(19) United States
(12) Patent Application Publication
(10) Pub. No.: US 2015/0119479 A1
(43) Pub. Date: Apr. 30, 2015

(54) SHAPE-MEMORY POLYMER WITH INTEGRAL RESISTIVE HEATING ELEMENT

(71) Applicant: Raytheon Company, Waltham, MA (US)

(72) Inventors: Frederick B. Koehler, Tucson, AZ (US); Terry M. Sanderson, Tucson, AZ (US)

(73) Assignee: Raytheon Company, Waltham, MA (US)

(21) Appl. No.: 14/066,647

(22) Filed: Oct. 29, 2013

(51) Int. Cl. B29C 61/06; B29C 61/00; C08J 9/00; B29C 67/00

(52) U.S. Cl. CPC B29C 61/0625; B29C 67/0059; B29C 61/003; C08J 9/00; B29K 2105/04
USPC 521/50; 264/479; 264/104; 425/132

(57) ABSTRACT

A method of making a reconfigurable three-dimensional shape includes the following steps: (i) moving multiple print heads in three dimensions relative to a printing surface, where the print heads include a conductor print head and a polymer print head; (ii) depositing a conductive material from the conductor print head; and (iii) depositing a shape-memory polymer from the polymer print head. The depositing steps form a volumetric shape of a shape-memory polymer, capable of changing shape, with a conductive material capable of acting as a heating element integrally formed in the volumetric shape. The method can further include the steps of heating the shape-memory polymer above a transition temperature, changing the shape of the volumetric shape following the heating step, and then allowing the shape-memory polymer to cool below the transition temperature to fix the new volumetric shape.

### FIELD OF THE INVENTION

The invention is related to shape-memory polymers and a method of constructing and activating products that include a shape-memory polymer in an ordered configuration.

### BACKGROUND

When heated above a transition temperature, shape-memory polymers are moldable and pliable and will return to their “memorized” shape if left unconstrained. If allowed to cool while constrained, the shape-memory polymers become hard and rigid in whatever shape they were left in when they were allowed to cool. Shape-memory polymers can be heated with external air, fluid, or inductive heating techniques, and each technique has advantages and disadvantages. Air heating requires a source of hot air. Fluid heating systems tend to be relatively heavy and require a pump to push fluid flow over the shape-memory polymer. And inductive heating systems tend to require a relatively large power supply, often making them impractical for field use.

### SUMMARY

The activation of a shape-memory polymer having a complex shape, such as a foam, through rapid and uniform heating has proven difficult, particularly in view of the thermal insulating characteristics of many polymers, and even greater thermal insulating characteristics of polymer foams. The present invention provides a material that includes a shape-memory polymer with an integral electrical resistance heating element that can be rapidly and uniformly heated even when the shape-memory polymer has a complex shape. This material is preferably formed using a three-dimensional printing technique to simultaneously build a polymer structure with an embedded conductive material that forms one or more electrical resistance heating elements. This technique allows the thickness of the conductive material and the polymer to be independently varied. As used here, the term “polymer” is synonymous with “shape-memory polymer”, which includes both polymers that have been altered to have shape-memory properties before or after it is formed into a shape using a three-dimensional printing technique. Polymers with shape-memory properties are moldable and pliable when heated above a transition temperature, and will return to a “memorized” shape if left unconstrained. If the shape-memory polymer is allowed to cool below the transition temperature it will become hard and rigid. And if it is allowed to cool while constrained, the shape-memory polymer will remain in whatever shape it was held in when it was allowed to cool below the transition temperature. Heating the shape-memory polymer above the transition temperature again will allow it to return to its memorized shape.

Accordingly, and more particularly, the present invention provides a three-dimensional printing machine that includes a printing surface and a plurality of print heads movable in three dimensions relative to the print surface upon which the print heads deposit material. The print heads include at least one polymer print head for dispensing a shape-memory polymer, and at least one conductor print head for dispensing an electrically-conductive material.

The printing machine can include a controller for controlling the relative position of the print heads and the printing surface and the dispensing of polymer and electrically-conductive material.

The printing machine also can include a supply of shape-memory polymer connected to the polymer print head and a supply of electrically-conductive material connected to the conductor print head. The polymer print head and/or the conductor print head can include an aerosol jet.

A shape-changeable device provided by the invention includes a volumetric shape composed of a shape-memory polymer and an integral electrically-conductive material that can act as a resistance heating element. Electricity supplied to the electrically-conductive material heats the shape-memory polymer above a transition temperature, causing the shape-memory polymer to soften, thereby permitting a change in the volumetric shape, and upon cooling the change in the volumetric shape is fixed by the stiffening of the shape-memory polymer.

The present invention also provides a method of making a reconfigurable three-dimensional shape that includes the following steps: (i) moving multiple print heads in three dimensions relative to a printing surface, where the print heads include a conductor print head and a polymer print head; (ii) depositing a conductive material from the conductor print head; and (iii) depositing a shape-memory polymer from the polymer print head. The depositing steps form a volumetric shape of a shape-memory polymer, capable of changing shape, with a conductive material capable of acting as a heating element integrally formed in the volumetric shape.

In one or more embodiments, the depositing steps take place at the same time; the depositing steps take place sequentially in a common layer; the step of depositing the conductive material includes depositing an electrically-conductive resistance element; the polymer-depositing step includes using an aerosol jet; and/or the conductor-depositing step includes using an aerosol jet and the polymer-depositing step includes using a three-dimensional material deposition process, such as the Fused Deposition Modeling™ process of Stratasys, Inc., of Eden Prairie, Minn., U.S.

The method can further include the step of heating the shape-memory polymer above a transition temperature. The heating step can include supplying electricity to the conductive material. The method also can further include the step of changing the shape of the volumetric shape following the heating step and then allowing the shape-memory polymer to cool below the transition temperature to fix the new volumetric shape.

Additionally or alternatively, the method can further include the step of adjusting one or more parameters during the forming steps, the parameters including the ratio of shape-memory polymer dispensed by the polymer print head to the conductive material dispensed by the conductor print head, the conductor thickness, the polymer thickness, and the conductive element type.

The foregoing and other features of the invention are hereinafter fully described and particularly pointed out in the claims, the following description and the annexed drawings setting forth in detail one or more illustrative embodiments of the invention. These embodiments, however, are but a few of the various ways in which the principles of the invention can be employed. Other objects, advantages and features of the invention will become apparent from the following detailed description of the invention when considered in conjunction with the drawings.

### BRIEF DESCRIPTION OF THE DRAWINGS

FIG. 1 is a schematic view of a three-dimensional printing machine provided in accordance with the invention.

FIG. 2 is a schematic view of a shape-memory polymer foam with an integrated resistive heating element provided by the invention and a source of electricity.

FIG. 3 is a perspective view of a shape-changeable device provided in accordance with the invention in a compact state.

FIG. 4 is a perspective view of the device of FIG. 3 in a larger deployed state.

### DETAILED DESCRIPTION

While the activation of a shape-memory polymer through rapid and uniform heating has proven difficult, particularly in view of the thermal insulating characteristics of many polymers, the present invention provides a solution. Specifically, the present invention provides a material including a shape-memory polymer with an integral electrical resistance heating element. This material is preferably formed using a three-dimensional printing technique to simultaneously build a three-dimensional polymer structure with an embedded conductive material, in the form of one or more wires, for example, that can form one or more electrical resistance heating elements, including a dispersed heating element.

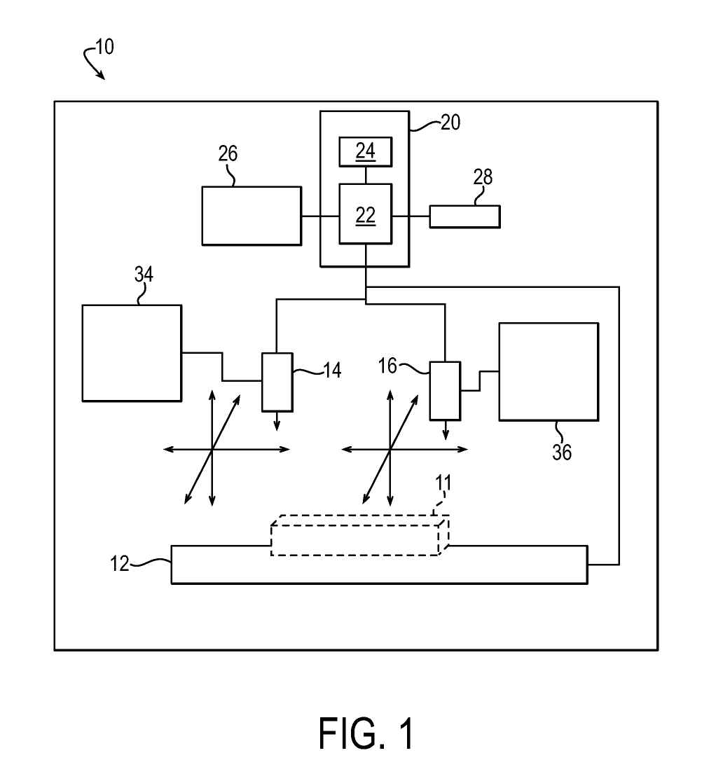

Referring now to the drawings and initially FIG. 1, the present invention provides a three-dimensional printing machine 10 for making the composite shape-memory polymer and conductive element in a desired volumetric shape 11, i.e., a three-dimensional or 3-D shape. The shape can be a complex angular or organic shape, or in the shape of a foam with integrated voids. Because the printing machine 10 builds the shape, the shape-memory polymer and conductive element can be deposited in such a way that the conductive element is placed precisely where it is needed and complex shapes can be created that would not be possible from casting or any other method. While integrated heating elements previously have been used in conjunction with shape-memory polymers, shape-memory polymers have not been printed using a 3-D printer to build a 3-D object. Three-dimensional printing makes it possible to make complex parts that could not have been made or could not have been built economically or with as much precision as 3-D printing has allowed.

The printing machine 10 includes a printing surface 12 and a plurality of print heads 14 and 16 movable in three dimensions relative to the printing surface 12 upon which the print heads 14 and 16 can deposit material. The print heads include at least one polymer print head 14 for dispensing a shape-memory polymer, and at least one conductor print head 16 for dispensing an electrically-conductive material. Although a few three-dimensional printing machines are known, for example, the machine disclosed in U.S. Pat. No. 6,259,962, the technology is relatively new and no known printing machines include separate print heads for depositing both a shape-memory polymer and a conductive material.

The printing machine 10 also includes a controller 20 for controlling the relative position of the print heads 14 and 16 and the printing surface 12 as well as the dispensing of a shape-memory polymer and an electrically-conductive material from respective print heads 14 and 16. The illustrated controller 20 includes a processor 22, such as a microprocessor, and a memory storage device 24, or memory, connected to the processor 22. The memory storage device 24 can store data, including software instructions for use by the processor 22. An input device 26, such as a keyboard, keypad, or pointing device, also can be provided and connected to the processor 22 to input data to the controller 20. Similarly, an output device 28, such as a display or a speaker, can be connected to the processor 22 to output data from the controller 20. Although controllers of this type are well known, the present invention is not limited to the illustrated controller, and it is the programming of dual print heads to deposit a shape-memory polymer and a conductive material substantially simultaneously that make this controller unique.

The printing machine 10 also can include or be connected to a supply 34 of shape-memory polymer or shape-memory polymer foam connected or connectable to the polymer print head 14 and a supply 36 of electrically-conductive material connected or connectable to the conductor print head 16. The polymer print head 14 and/or the conductor print head 16 can include an aerosol jet nozzle to deposit material. The polymer print head 14 alternatively can include an extrusion nozzle to deposit material using a material deposition process, such as the Fused Deposition Modeling™ process of Stratasys, Inc., of Eden Prairie, Minn., U.S. The shape-memory polymer can be dispensed in the form of a foam, with many voids or as a substantially continuous, i.e., solid, material. Additionally, a polymer without shape-memory properties can be dispensed and subsequently altered to have shape-memory properties. Further references to dispensing shape-memory polymer include this possibility.

Using separate print heads 14 and 16 to deposit the shape-memory polymer and the conductive material allows the conductor conductivity/resistivity to be continuously adjusted by adjusting the conductor/polymer ratio and/or the conductor thickness and/or the conductive material, typically a metal. The conductive material generally is deposited to form a substantially continuous conductive element or elements, each typically having a wire-like or rope-like shape. As a foam, the polymeric material is interspersed with a plurality of voids, similar to a sponge. Since the purpose of the conductive material is to heat the polymeric shape-memory material, the three-dimensional printing process preferably surrounds the conductive material with polymeric material, rather than having the conductive material pass through a void in the polymeric material. The three-dimensional printing machine 10 thus permits the construction of a more efficiently-heated and reconfigured structure. The three-dimensional printing machine 10 also makes it much easier to form complex three-dimensional shapes using a variety of polymers that have shape-memory properties.

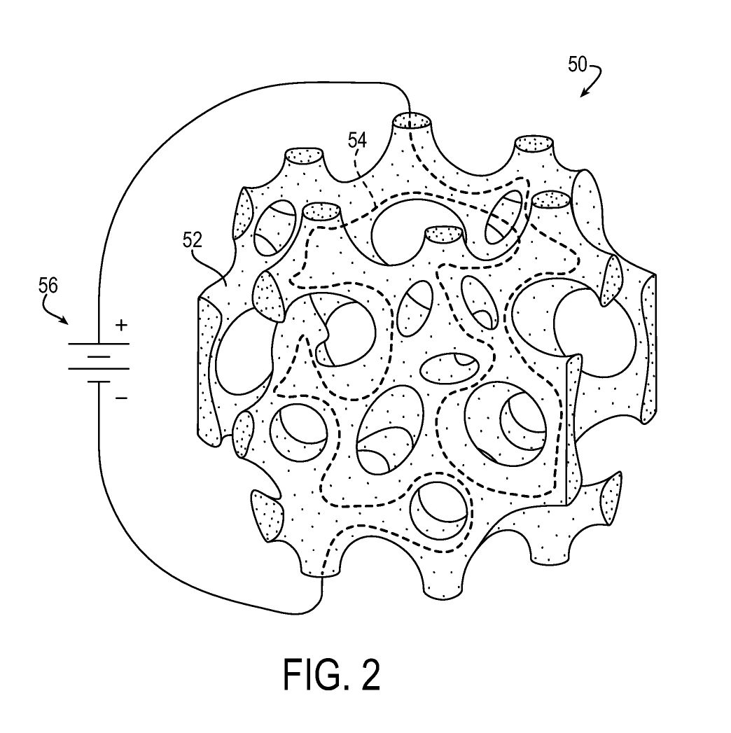

Referring now to FIG. 2, the present invention also provides a reconfigurable, shape-changeable device 50 that includes a volumetric shape composed of a shape-memory polymer or polymer foam 52 and an integral electrically-conductive material 54 that can act as a resistance heating element. A supply of electricity 56, such as a battery, can be connected to the electrically-conductive material 54 to heat the shape-memory polymer foam 52 above a transition temperature, causing the shape-memory polymer foam 52 to soften, thereby permitting a change in the volumetric shape. If the shape-memory polymer foam 52 is in its memory configuration, the device 50 will have to be manipulated and held in the desired position. Otherwise, the shape-memory polymer foam 52 will attempt to return to its memory configuration automatically. Upon cooling, the change in the volumetric shape is fixed by the stiffening of the shape-memory polymer foam 52.

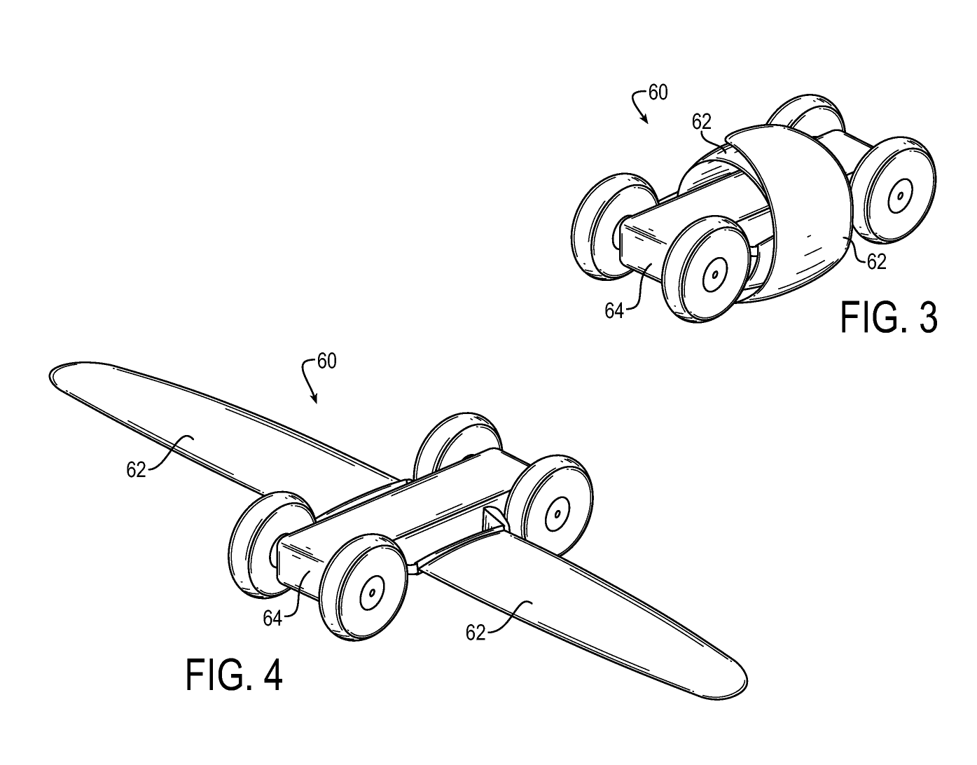

As a result, objects that take up a lot of space can be stored or transported in a compact state, and upon connecting it to or otherwise turning on a supply of electricity connected to the conductive material 54, the object can be quickly heated and unfolded to a larger deployed state for final assembly and use. For example, FIGS. 3 and 4 illustrate a small airplane 60 with wings 62 made of a material provided by the invention. The airplane 60 can be stored and transported with its wings 62 folded around a main body 64 (FIG. 3). Upon heating, the wings 62 can be unfolded and extended, either automatically as they return to a deployed configuration (FIG. 4) or by manipulating the wings 62 away from a compact memory configuration (FIG. 3). The electricity can then be turned off or disconnected from the conductive material in the wings 62 and the wings 62 can be allowed to cool, whereupon the wings 62 will have the rigidity and stiffness necessary for the airplane 60 to fly. As can be seen in this example, in the deployed state of FIG. 4 the device, in this case an airplane 60, takes up a larger volume than in the compact state of FIG. 3. Upon reheating, the wings 62 will soften once again and the wings 62 can be returned to the compact state of FIG. 3, either automatically due to the foam's shape-memory properties or by manipulating the wings 62 back to the compact state if the deployed state is the natural configuration toward which the shape-memory properties bias the wings 62.

The concepts provided by the invention can be used for any purpose where a change in shape is desired, such as for shipping in a compact state and subsequent deployment in a larger-volume deployed state. Some examples include aquatic or aeronautical structures, such as airplane wings or other control surfaces, helicopter rotors, rocket fins or other control surfaces, robots, and field-assembled or deployed land structures, for example. But that is not the only use for the inventive concepts provided by the invention. Other examples of shape-changeable objects provided by the invention include car seats that can be custom-molded to the shape of each driver, and rental ski boots that can be custom molded to each skier's foot, among many other applications.

The present invention also provides a method of making a reconfigurable three-dimensional shape that includes the following steps: (i) moving multiple print heads in three dimensions relative to a printing surface, where the print heads include a conductor print head and a polymer print head; (ii) depositing a conductive material from the conductor print head; and (iii) depositing a shape-memory polymer from the polymer print head. The depositing steps form a volumetric shape of a shape-memory polymer, capable of changing shape, with a conductive material capable of acting as a heating element integrally formed in the volumetric shape.

In one or more embodiments, the depositing steps take place at the same time; the depositing steps take place sequentially in a common layer; the step of depositing the conductive material includes depositing an electrically-conductive resistance element; the polymer-depositing step includes using an aerosol jet nozzle; and/or the conductor-depositing step includes using an aerosol jet nozzle and the polymer-depositing step includes using an extrusion nozzle in a three-dimensional material deposition process, such as the Fused Deposition Modeling™ process.

The method can further include the step of heating the shape-memory polymer above a transition temperature, such as by supplying electricity to the conductive material. The method also can further include the step of changing the shape of the volumetric shape following the heating step and then allowing the shape-memory polymer foam to cool below the transition temperature to fix the new volumetric shape. Thus the object can be reconfigured between a compact state and a larger deployed state, and back again.

Additionally or alternatively, the method can further include the step of adjusting one or more parameters during the forming steps, the parameters including the ratio of shape-memory polymer dispensed by the polymer print head to the conductive material dispensed by the conductor print head, the conductor thickness, the polymer thickness, the amount and size of voids in the shape-memory polymer, and the conductive element type. And as another alternative, the present invention provides a method of making a reconfigurable three-dimensional shape, includes the steps of (a) moving multiple print heads in three dimensions relative to a printing surface, where the print heads include a conductor print head and a polymer print head; (b) depositing a conductive material from the conductor print head; (c) depositing a polymer from the polymer print head; and (d) altering the polymer to include shape-memory properties. The depositing steps form a volumetric shape with a conductive material capable of acting as a heating element integrally formed in the volumetric shape.

In one or more embodiments, the altering step occurs before the depositing step.

In summary, the present invention provides a method of making a reconfigurable three-dimensional shape includes the following steps: (i) moving multiple print heads in three dimensions relative to a printing surface, where the print heads include a conductor print head and a polymer print head; (ii) depositing a conductive material from the conductor print head; and (iii) depositing a shape-memory polymer from the polymer print head. The depositing steps form a volumetric shape of a shape-memory polymer, capable of changing shape, with a conductive material capable of acting as a heating element integrally formed in the volumetric shape. The method can further include the steps of heating the shape-memory polymer above a transition temperature, changing the shape of the volumetric shape following the heating step, and then allowing the shape-memory polymer to cool below the transition temperature to fix the new volumetric shape.

Although the invention has been shown and described with respect to certain preferred embodiments, it is obvious that equivalent alterations and modifications will occur to others skilled in the art upon the reading and understanding of this specification and the annexed drawings. In particular regard to the various functions performed by the above described components, the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention.

What is claimed is:

1. A method of making a reconfigurable three-dimensional shape, comprising the steps of:
moving multiple print heads in three dimensions relative to a printing surface, where the print heads include a conductor print head and a polymer print head;
depositing a conductive material from the conductor print head; and
depositing a shape-memory polymer from the polymer print head;
whereby the depositing steps form a volumetric shape of a shape-memory polymer, capable of changing shape, with a conductive material capable of acting as a heating element integrally formed in the volumetric shape.

2. A method as set forth in claim 1 or any other method claim, where the depositing steps take place at the same time.

3. A method as set forth in claim 1 or any other method claim, where the depositing steps take place sequentially in a common layer.

4. A method as set forth in claim 1 or any other method claim, where the step of depositing the conductive material includes depositing an electrically-conductive resistance element.

5. A method as set forth in claim 1 or any other method claim, comprising the step of heating the shape-memory polymer above a transition temperature.

6. A method as set forth in claim 5 or any other method claim, where the heating step includes supplying electricity to the conductive material.

7. A method as set forth in claim 5 or any other method claim, comprising the step of changing the shape of the volumetric shape following the heating step and then allowing the shape-memory polymer to cool below the transition temperature to fix the new volumetric shape.

8. A method as set forth in claim 1 or any other method claim, comprising the step of adjusting one or more parameters during the forming steps, the parameters including the ratio of shape-memory polymer dispensed by the polymer print head to the conductive material dispensed by the conductor print head, the conductor thickness, the polymer thickness, the amount of and size of voids in the polymer, and the conductive element type.

9. A method as set forth in claim 1 or any other method claim, where the polymer-depositing step includes using an aerosol jet.

10. A method as set forth in claim 1 or any other method claim, where the conductor-depositing step includes using an aerosol jet and the polymer-depositing step includes using a three-dimensional material deposition process.

11. A method as set forth in claim 1 or any other method claim, where the polymer-depositing step includes forming a polymer foam having a plurality of voids.

12. A three-dimensional printing machine, comprising:
a printing surface and a plurality of print heads movable in three dimensions relative to the print surface upon which the print heads deposit material, the print heads including at least one polymer print head for dispensing a shape-memory polymer, and at least one conductor print head for dispensing an electrically-conductive material.

13. A printing machine as set forth in claim 12 or any other printing machine claim, where the printing machine includes a controller for controlling the relative position of the print heads and the printing surface and the dispensing of a shape-memory polymer and an electrically-conductive material.

14. A printing machine as set forth in claim 12 or any other printing machine claim, comprising a supply of shape-memory polymer connected to the polymer print head and a supply of electrically-conductive material connected to the conductor print head.

15. A printing machine as set forth in claim 12 or any other printing machine claim, where the polymer print head includes an aerosol jet.

16. A printing machine as set forth in claim 12 or any other printing machine claim, where the conductor print head includes an aerosol jet.

17. A shape-changeable device, comprising a volumetric shape composed of a shape-memory polymer and an integral electrically-conductive material that can act as a resistance heating element, whereby electricity supplied to the electrically-conductive material heats the shape-memory polymer above a transition temperature, causing the shape-memory polymer to soften, thereby permitting a change in the volumetric shape, and upon cooling the change in the volumetric shape is fixed by the stiffening of the shape-memory polymer.

18. A method of making a reconfigurable three-dimensional shape, comprising the steps of:
moving multiple print heads in three dimensions relative to a printing surface, where the print heads include a conductor print head and a polymer print head;
depositing a conductive material from the conductor print head; and
depositing a polymer from the polymer print head;
altering the polymer to include shape-memory properties;
whereby the depositing steps form a volumetric shape with a conductive material capable of acting as a heating element integrally formed in the volumetric shape.

19. A method as set forth in claim 18, where the altering step occurs before the depositing step.
